(19) United States
(12) Patent Application Publication
(10) Pub. No.: US 2013/0191366 A1
(43) Pub. Date: Jul. 25, 2013

(54) Pattern Matching Engine

(71) Applicants: Vuk Jovanovic, Valjevo (RS); Milos Lazarevic, Belgrade (RS); Milos Raskovic, Belgrade (RS); Nenad Bozidarevic, Belgrade (RS); Milan Sesum, Belgrade (RS)

(72) Inventors: Vuk Jovanovic, Valjevo (RS); Milos Lazarevic, Belgrade (RS); Milos Raskovic, Belgrade (RS); Nenad Bozidarevic, Belgrade (RS); Milan Sesum, Belgrade (RS)

(73) Assignee: MICROSOFT CORPORATION, Redmond, WA (US)

(21) Appl. No.: 13/521,416

(22) PCT Filed: Jan. 23, 2012
(86) PCT No.: PCT/EP2012/000290

§ 371 Date: Jul. 10, 2012

(30) Foreign Application Priority Data
Jan. 23, 2012 (EP) PCT/EP2012/000290

(51) Int. Cl. G06F 17/30

(52) U.S. Cl. 707/710; 707/E17.108

(57) ABSTRACT

A pattern matching engine and associated method for detecting one or more of headers, footers, watermarks, page numbering, page colors, and page borders appearing in a fixed format document. The pattern matching engine performs pattern matching across pages of the fixed format document to identify repeating patterns. Using heuristic analysis, repeating patterns meeting selected criteria are classified as headers, footers, or watermarks. Filtering removes repeating patterns unlikely to represent headers, footers, or watermarks. The information produced by the pattern matching engine allows the repeating elements to be properly reconstructed as flowable elements when converting a fixed format document into a flow format document.

### BACKGROUND

Flow format documents and fixed format documents are widely used and have different purposes. Flow format documents organize a document using complex logical formatting structures such as sections, paragraphs, columns, and tables. As a result, flow format documents offer flexibility and easy modification making them suitable for tasks involving documents that are frequently updated or subject to significant editing. In contrast, fixed format documents organize a document using basic physical layout elements such as text runs, paths, and images to preserve the appearance of the original. Fixed format documents offer consistent and precise format layout making them suitable for tasks involving documents that are not frequently or extensively changed or where uniformity is desired. Examples of such tasks include document archival, high-quality reproduction, and source files for commercial publishing and printing. Fixed format documents are often created from flow format source documents. Fixed format documents also include digital reproductions (e.g., scans and photos) of physical (i.e., paper) documents.

In situations where editing of a fixed format document is desired but the flow format source document is not available, the fixed format document must be converted into a flow format document. Conversion involves parsing the fixed format document and transforming the basic physical layout elements from the fixed format document into the more complex logical elements used in a flow format document. Existing document converters faced with complex elements, such as watermarks, headers, footers, and page numbering, resort to base techniques designed to preserve the visual fidelity of the layout (e.g., text frames, line spacing, and character spacing) at the expense of the flowability of the output document. The result is a limited flow format document that requires the user to perform substantial manual reconstruction to have a truly useful flow format document. It is with respect to these and other considerations that the present invention has been made.

### BRIEF SUMMARY

The following Brief Summary is provided to introduce a selection of concepts in a simplified form that are further described below in the Detailed Description. This Brief Summary is not intended to identify key features or essential features of the claimed subject matter, nor is it intended to be used to limit the scope of the claimed subject matter.

In various embodiments, the pattern matching engine detects elements that form a repeating pattern in a fixed format document. In order to reliably detect a large number of repeating patterns, the pattern matching engine detects basic repeating patterns in the fixed format document as candidates. A repeating pattern is formed when an element appears in similar or substantially consistent positions on each page and with similar or substantially identical content on a selected number of pages in the fixed format document. First, the pattern matching engine identifies watermark candidates. Page borders and page color are treated as specialized watermarks. A watermark typically repeats the same content on each page of the fixed format document and in the same position. After detecting watermarks, the pattern matching engine looks for header and footer candidates. To detect header and footer candidates, the pattern matching engine determines when the upper or lower parts of a certain number of pages contain the same or similar content at the same position.

To identify dynamic elements, such as page numbers, the pattern matching engine compares the content of the elements that appear on consecutive pages. If the text run being considered on the first page contains a number and the text run being considered on the second page also contains a number and the value of that number increases by one from the first page to the second page, the elements are detected as page numbering.

In order to reliably detect a large number of repeating patterns, the pattern matching engine looks for basic repeating patterns. As a result, repeating elements that are not watermarks, page borders, page colors, headers, footers, or page numbers are detected as candidates. One filter discards candidates that do not repeat a minimum number of times. Another filter discards candidates appearing intermittently or randomly throughout the fixed format document and are separated by multiple pages. Other filters discard line numbers and repeating elements that are recognized as other objects, such as table headers. After filtering, the pattern matching engine classifies candidates matching the appropriate criteria a header, footer, or watermark.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

Further features, aspects, and advantages will become better understood by reference to the following detailed description, appended claims, and accompanying figures, wherein elements are not to scale so as to more clearly show the details, wherein like reference numbers indicate like elements throughout the several views, and wherein:

FIG. 1 is a block diagram showing one embodiment of system including the pattern matching engine;

FIG. 2 is a block diagram showing the operational flow of one embodiment of the document processor;

FIGS. 3A-3D illustrate various repeating patterns appearing in fixed format documents that are processed by the pattern matching engine;

FIGS. 4A-4B are a flow chart showing one embodiment of the pattern matching method for detecting headers, footers, and watermarks;

FIG. 5 illustrates one embodiment of a tablet computing device executing one embodiment of the pattern matching engine;

FIG. 6 is a simplified block diagram of one embodiment of a computing device with which embodiments of the present invention may be practiced;

FIG. 7A illustrates one embodiment of a mobile computing device executing one embodiment of the pattern matching engine;

FIG. 7B is a simplified block diagram of one embodiment of a mobile computing device with which embodiments of the present invention may be practiced; and

FIG. 8 is a simplified block diagram of a distributed computing system in which embodiments of the present invention may be practiced.

### DETAILED DESCRIPTION

A pattern matching engine and associated method for detecting one or more of headers, footers, watermarks, page numbering, page colors, and page borders appearing a fixed format document is described herein and illustrated in the accompanying figures. The pattern matching engine performs pattern matching across pages of the fixed format document to identify repeating patterns. Using heuristic analysis, repeating patterns meeting selected criteria are classified as headers, footers, or watermarks. Filtering removes repeating patterns unlikely to represent headers, footers, or watermarks. The information produced by the pattern matching engine allows the repeating elements to be properly reconstructed as flowable elements when converting a fixed format document into a flow format document.

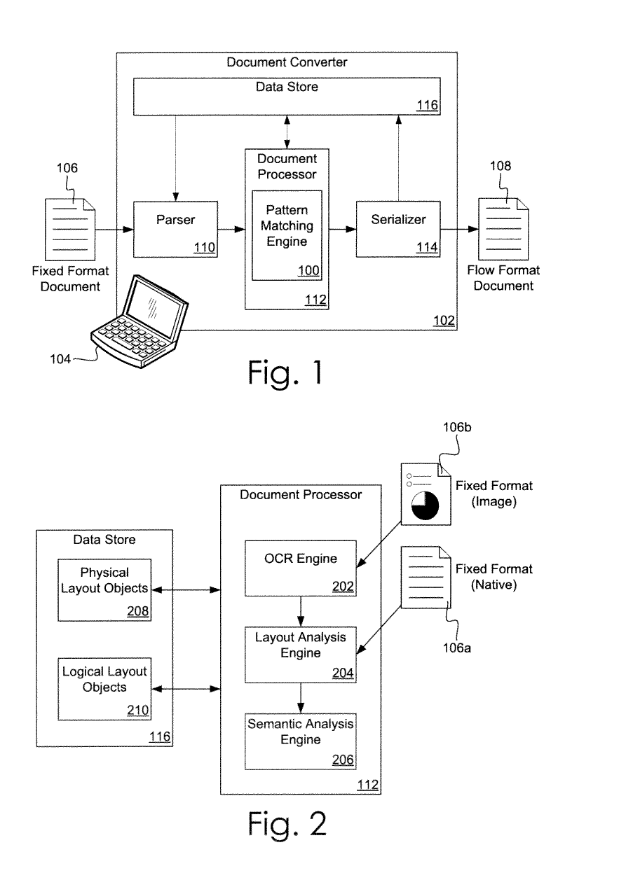

FIG. 1 illustrates a system incorporating the pattern matching engine 100. In the illustrated embodiment, the pattern matching engine 100 operates as part of a document converter 102 executed on a computing device 104. The document converter 102 converts a fixed format document 106 into a flow format document 108 using a parser 110, a document processor 112, and a serializer 114. The parser 110 extracts data from the fixed format document 106. The data extracted from the fixed format document is written to a data store 116 accessible by the document processor 112 and the serializer 114. The document processor 112 analyzes and transforms the data into flowable elements using one or more detection and/or reconstruction engines (e.g., the pattern matching engine 100 of the present invention). Finally, the serializer 114 writes the flowable elements into a flowable document format (e.g., a word processing format).

FIG. 2 illustrates one embodiment of the operational flow of the document processor 112 in greater detail. The document processor 112 includes an optional optical character recognition (OCR) engine 202, a layout analysis engine 204, and a semantic analysis engine 206. The data contained in the data store 116 includes physical layout objects 208 and logical layout objects 210. In some embodiments, the physical layout objects 208 and logical layout objects 210 are hierarchally arranged in a tree-like array of groups (i.e., data objects). In various embodiments, a page is the top level group for the physical layout objects 208, and a section is the top level group for the logical layout objects 210. The data extracted from the fixed format document 106 is generally stored as physical layout objects 208 organized by the containing page in the fixed format document 106. The basic physical layout objects obtained from a fixed format document include text-runs, images, and paths. Text-runs are the text elements in page content streams specifying the positions where characters are drawn when displaying the fixed format document. Images are the raster images (i.e., pictures) stored in the fixed format document 106. Paths describe elements such as lines, curves (e.g., cubic Bezier curves), and text outlines used to construct vector graphics. Logical data objects include flowable elements such as sections, paragraphs, columns, and tables.

Where processing begins depends on the type of fixed format document 106 being parsed. A native fixed format document 106a created directly from a flow format source document contains the some or all of the basic physical layout elements. Generally, the data extracted from a native fixed format document 106a is available for immediate use by the document converter; although, in some instances, minor reformatting or other minor processor is applied to organize or standardize the data. In contrast, all information in an image-based fixed format document 106b created by digitally imaging a physical document (e.g., scanning or photographing) is stored as a series of page images with no additional data (i.e., no text-runs or paths). In this case, the optional optical character recognition engine 202 analyzes each page image and creates corresponding physical layout objects. Once the physical layout objects 208 are available, the layout analysis engine 204 determines the layout of the fixed format document and enriches the data store with new information (e.g., adds, removes, and updates the physical layout objects). After layout analysis is complete, the semantic analysis engine 206 enriches the data store with semantic information obtained from analysis of the physical layout objects and/or logical layout objects.

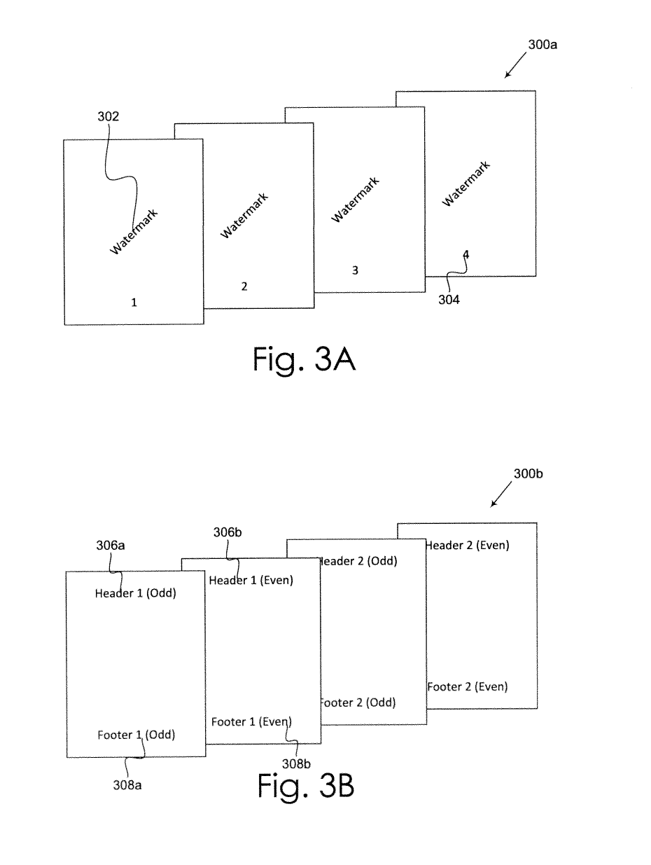

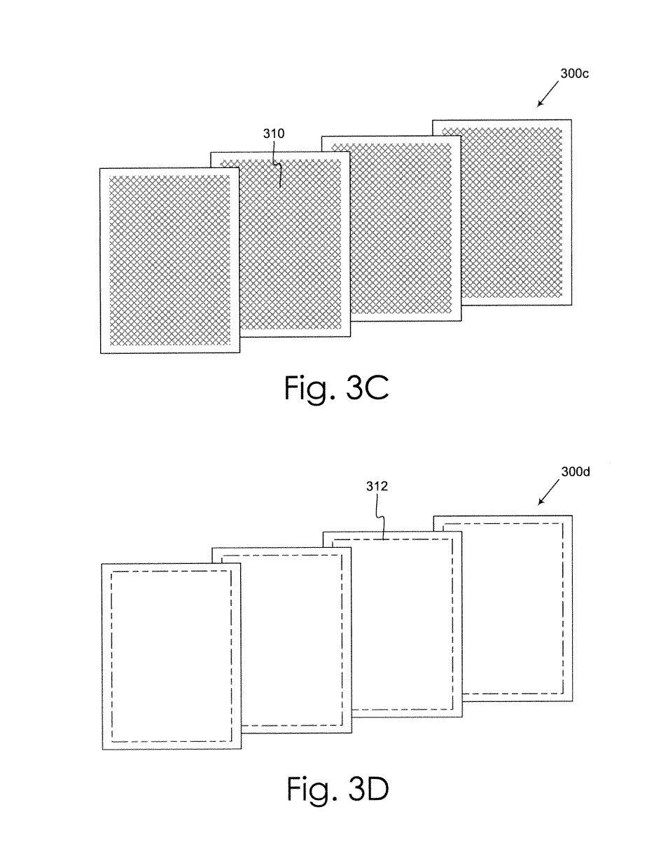

FIGS. 3A-3D illustrate various repeating elements appearing on different pages of a fixed format document 300a-d. FIG. 3A illustrates a fixed format document 300a with a watermark 302 and a page number 304. FIG. 3B illustrates a fixed format document 300b with a first header appearing on odd pages 306a, a first footer appearing on odd pages 308a, a second header on appearing even pages 306b, and a second footer on appearing even pages 308b. FIG. 3C illustrates a fixed format document 300c with a page color 310. FIG. 3D illustrates a fixed format document 300d with a page border 312.

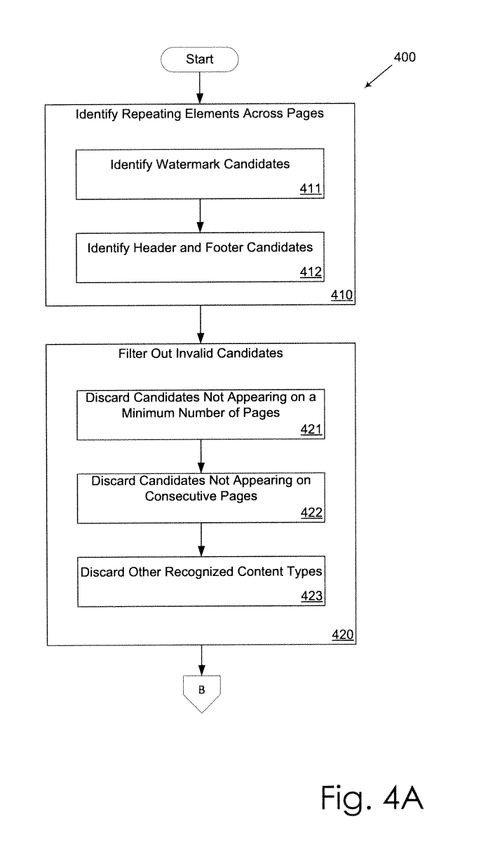

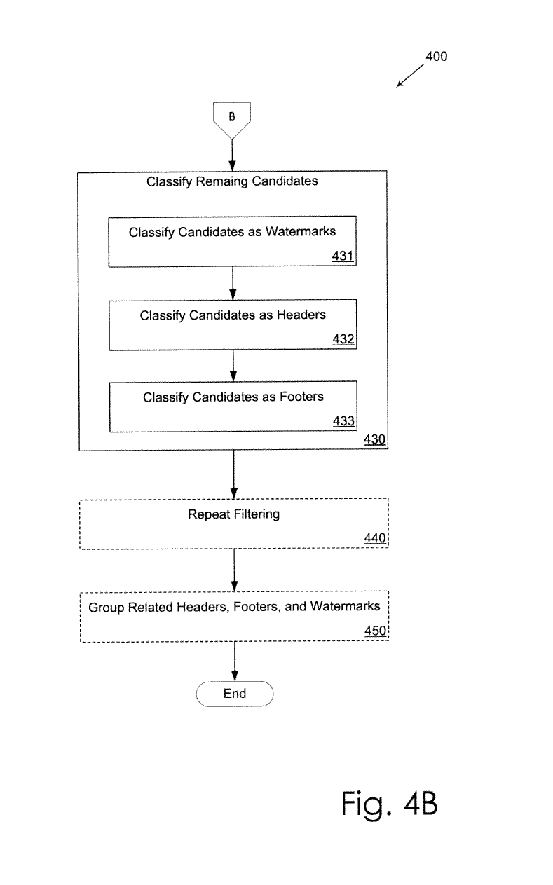

FIGS. 4A-4B are a flow diagram showing one embodiment of the pattern matching method 400 used to detect watermarks, page colors, page borders, headers, footers, and page numbers executed by the pattern matching engine 100. In order to reliably detect a large number of repeating patterns, the pattern matching engine 100 detects 410 basic repeating patterns in the fixed format document as candidates. A repeating pattern is formed when an element (e.g., an image, path, or text run) appears in similar or substantially consistent positions on each page and with similar or substantially identical content on a selected number of pages in the fixed format document. First, the pattern matching engine 100 identifies 411 watermark candidates. Page borders and page color are treated as specialized watermarks. A watermark typically repeats the same content on each page of the fixed format document and in the same position. Similarly, a page border and page color identically repeat at the same position on each page of the fixed format document. To identify page border candidates, the pattern matching engine 100 looks for a group of elements connected to each other and spanning a substantial portion of the page.

After detecting watermark candidates, page borders, and page colors, the pattern matching engine 100 looks 412 for header and footer candidates. To detect header and footer candidates, the pattern matching engine 100 determines when the upper or lower parts of a certain number of pages contain the same or similar content at the same position. When the upper or lower parts of the pages contain the same content in the same position, the pattern matching engine 100 easily classifies the element as a header or footer, as appropriate. In cases where the elements on different pages have similar content in the same position, the pattern matching engine 100 examines the content to look for dynamic elements.

To identify dynamic elements, such as text runs containing page numbers, the pattern matching engine 100 compares the content of the elements that appear on consecutive pages. If the text runs on the two consecutive pages contains a number in similar positions on the pages and the value of that number increases by one from the first page to the second page, the elements classified as page numbering. In some embodiments, roman numerals are identified and checked for an increase by one. In various embodiments, alphanumeric characters other than numbers are also considered as page numbers 304 by checking if the ASCII code or Unicode value of the character increases by one. In addition to evaluating consecutive pages, the pattern matching engine 100 compares potential header and footer candidates on alternating pages to account for odd and even page headers 306a, 306b and footers 308a, 308b. In such a case, the potential page number 304 is permitted an increment of two.

Once the repeating patterns in the fixed format document have been detected, one or more filters discard 420 the repeating patterns that have characteristics resulting in a low probability that the repeating pattern is a watermark, page border, page color, header, footer, or page number. One filter discards 421 candidates that do not repeat a minimum number of times. In the various embodiments, a candidate that does not repeat three or more times is discarded. Another filter discards 422 lonely candidates. Candidates that appear occasionally or randomly throughout the fixed format document and separated by multiple pages are considered lonely elements. For example, when a candidate that appears on pages 2, 9, and 15, the candidates are not valid repeating elements because there are no two consecutive pages where the candidates appear. Yet another filter discards 423 repeating elements that are recognized as other types of content (e.g., line numbering or tables) and more properly classified as such. To filter other recognized objects, the page containing the repeating element is analyzed. If the repeating element is of some other recognized type of content (e.g., a table), that element is consumed. The repeating element remains a candidate only if any portion of the recognized element is not consumed and contains repeating elements, those elements would remain candidates; however, if only parts of the recognized content are candidates, all candidates associated with that recognized element are discarded.

After filtering, the pattern matching engine 100 classifies 430 candidates matching the appropriate criteria a header 306a, 306b, footer 308a, 308b, or watermark 302. In various embodiments, the pattern matching engine 100 classifies 431a repeating element as a watermark if that element repeats across all pages beginning with the second page. In other words, the repeating element need not appear on the first page to be classified as watermark. In some embodiments, a repeating element appearing on three or more pages is classified as a watermark.

In addition to meeting the basic requirements of a watermark 302, some embodiments of the pattern matching engine 100 impose additional constraints on page colors 310 and page borders 312. In various embodiments, the pattern matching engine 100 classifies a repeating element as a page color 310 only if the coverage area exceeds selected percentage of the page specified by a minimum page coverage area percentage threshold corresponding to a majority or substantially all of the area of the page. In other embodiments, the height and/or width of the bounding box of the element must exceed the corresponding minimum height and/or width thresholds before the element is classified as a page color 310 or page border 312. In some embodiments, the area of the page contained by the connected elements must exceed a minimum page containment area percentage threshold before the connected elements are classified as a page border. In the various embodiments, the minimum page coverage area percentage threshold, the minimum height and/or width thresholds, and the minimum page containment area percentage threshold vary.

The pattern matching engine 100 classifies 432 a candidate as a header 306a, 306b if the candidate is the topmost element on the page or the only other elements vertically above the candidate are also classified as headers. Candidates that vertically overlap a header by more than a selected amount are not classified as headers. Footers 308a, 308b are classified 433 in the same manner looking at the bottommost elements. Candidates that remain unclassified are discarded. Some embodiments of the pattern matching engine 100 perform 440 another filter operation after classification identifying any classified candidates that have become lonely candidates or do not meet the minimum number of repetitions.

Finally, the related headers, the related footers, and the related watermarks are optionally placed 450 into appropriate groups. In other words, distinct instances of headers, footers, and watermarks are placed into separate groups. For example, odd page headers are placed in one group while even page headers are placed in another group. Similarly, if the header changes between pages (e.g., a chapter header), those headers are placed in different groups. The different groups may be stored in different logical objects (e.g., section objects), and such information may be used during serialization to create flowable elements.

The pattern matching engine 100 and associated pattern matching method 400 described herein is useful to identify and classify headers, footers, and watermarks appearing in a fixed format document. By detecting headers, footers, and watermarks in a fixed format document, the pattern matching engine 100 allows the corresponding flowable elements to be created during serialization. In contrast, prior document conversion techniques generally place content at the top or bottom of a fixed page document into a text box or frame during serialization or treat the content as an image. While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

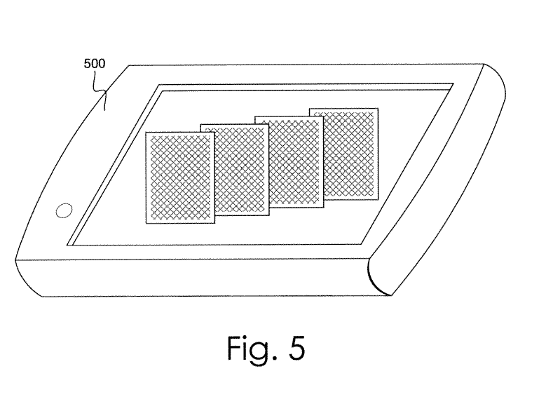

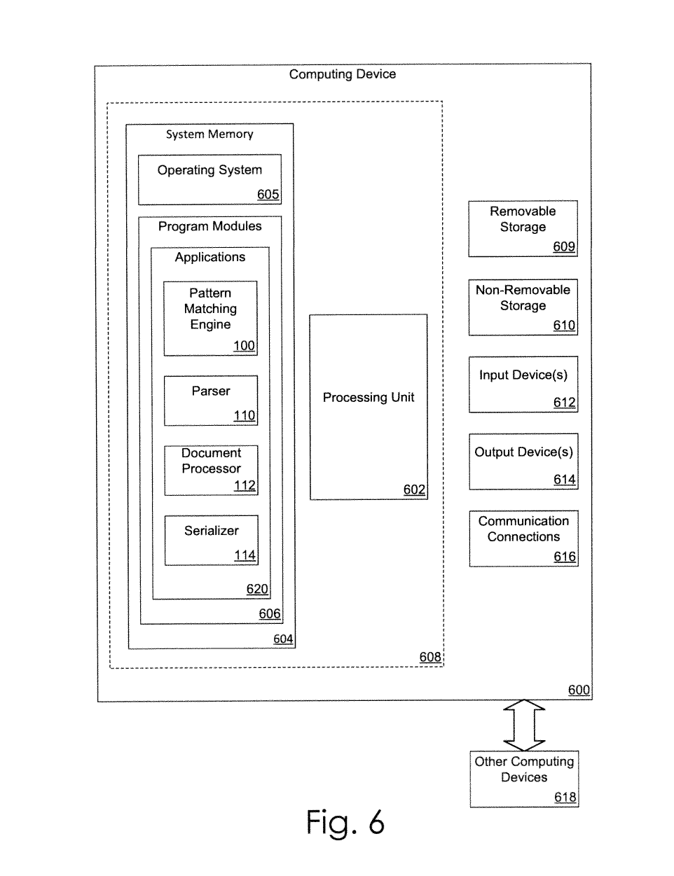

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. FIG. 5 illustrates an exemplary tablet computing device 500 executing an embodiment of the pattern matching engine 100. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 6 through 8 and the associated descriptions provide a discussion of a variety of operating environments in which embodiments of the invention may be practiced. However, the devices and systems illustrated and discussed with respect to FIGS. 6 through 8 are for purposes of example and illustration and are not limiting of a vast number of computing device configurations that may be utilized for practicing embodiments of the invention, described herein.

FIG. 6 is a block diagram illustrating example physical components (i.e., hardware) of a computing device 600 with which embodiments of the invention may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 620 such as the pattern matching engine 100, the parser 110, the document processor 112, and the serializer 114. The operating system 605, for example, may be suitable for controlling the operation of the computing device 600. Furthermore, embodiments of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606, such as the pattern matching engine 100, the parser 110, the document processor 112, and the serializer 114 may perform processes including, for example, one or more of the stages of the pattern matching method 400. The aforementioned process is an example, and the processing unit 602 may perform other processes. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the pattern matching engine 100, the parser 110, the document processor 112, and the serializer 114 may be operated via application-specific logic integrated with other components of the computing device 600 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 600 may have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may also include one or more communication connections 616 allowing communications with other computing devices 618. Examples of suitable communication connections 616 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communications media. Computer storage media may include volatile and nonvolatile, removable and non-removable media implemented in any method or technology for storage of information, such as computer readable instructions, data structures, program modules, or other data. The system memory 604, the removable storage device 609, and the non-removable storage device 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 600. Any such computer storage media may be part of the computing device 600.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

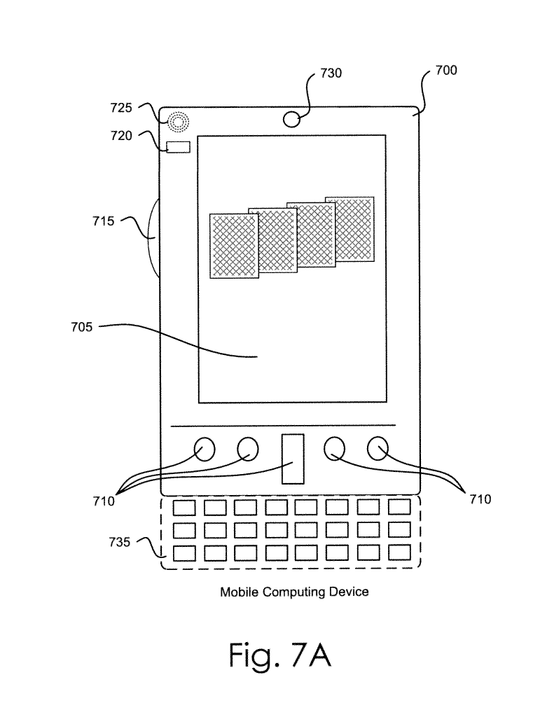

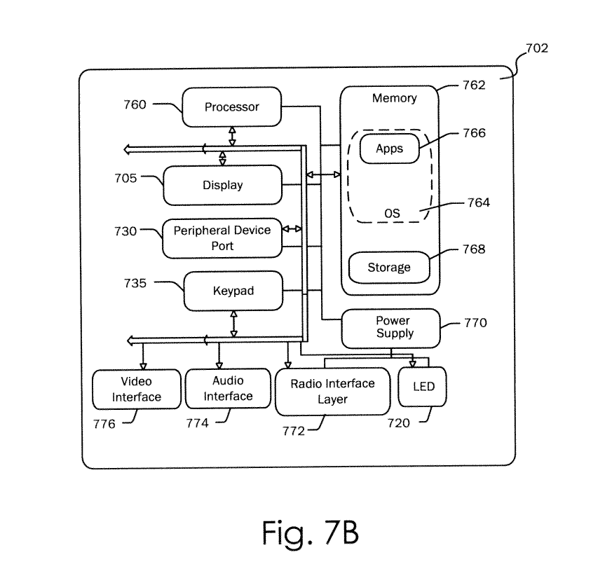

FIGS. 7A and 7B illustrate a mobile computing device 700, for example, a mobile telephone, a smart phone, a tablet personal computer, a laptop computer, and the like, with which embodiments of the invention may be practiced. With reference to FIG. 7A, an exemplary mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker).

In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the pattern matching engine 100, the parser 110, the document processor 112, and the serializer 114 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world”, via a communications carrier or service provider. Transmissions to and from the radio 772 are conducted under control of the operating system 764. In other words, communications received by the radio 772 may be disseminated to the application programs 766 via the operating system 764, and vice versa.

The radio 772 allows the system 702 to communicate with other computing devices, such as over a network. The radio 772 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 702 provides notifications using the visual indicator 720 that can be used to provide visual notifications and/or an audio interface 774 producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present invention, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768. Computer storage media may include volatile and nonvolatile, removable and non-removable media implemented in any method or technology for storage of information, such as computer readable instructions, data structures, program modules, or other data.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

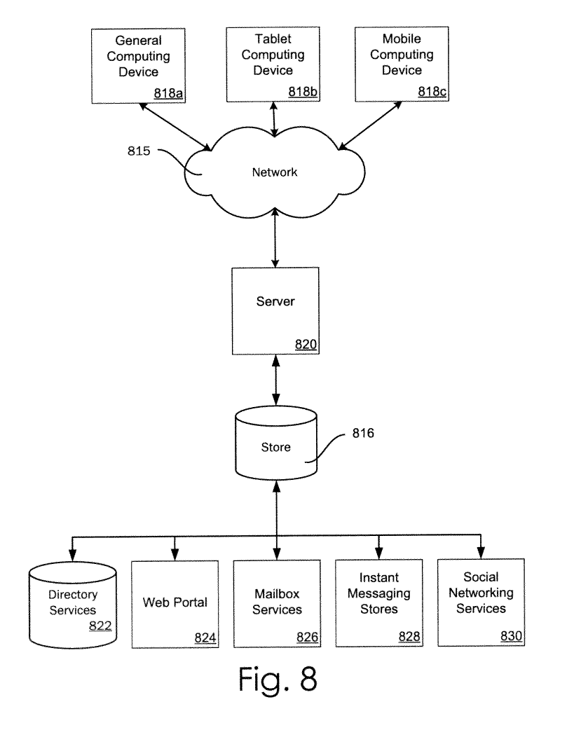

FIG. 8 illustrates one embodiment of the architecture of a system for providing the pattern matching engine 100, the parser 110, the document processor 112, and the serializer 114 to one or more client devices, as described above. Content developed, interacted with or edited in association with the pattern matching engine 100, the parser 110, the document processor 112, and the serializer 114 may be stored in different communication channels or other storage types. For example, various documents may be stored using a directory service 822, a web portal 824, a mailbox service 826, an instant messaging store 828, or a social networking site 830. The pattern matching engine 100, the parser 110, the document processor 112, and the serializer 114 may use any of these types of systems or the like for enabling data utilization, as described herein. A server 820 may provide the pattern matching engine 100, the parser 110, the document processor 112, and the serializer 114 to clients. As one example, the server 820 may be a web server providing the pattern matching engine 100, the parser 110, the document processor 112, and the serializer 114 over the web. The server 820 may provide the pattern matching engine 100, the parser 110, the document processor 112, and the serializer 114 over the web to clients through a network 815. By way of example, the client computing device 818 may be implemented as the computing device 600 and embodied in a personal computer 818a, a tablet computing device 818b and/or a mobile computing device 818c (e.g., a smart phone). Any of these embodiments of the client computing device 818 may obtain content from the store 816. In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

What is claimed is:

1. A pattern matching method for identifying and classifying elements repeating on different pages of a fixed format document, said method comprising the steps of:
identifying elements as candidates when said elements have similar content and appear at similar positions on multiple pages of the fixed format document;
discarding said candidates that match a filter criterion; and
selectively classifying a selected said candidate as a header, a footer, or a watermark when said candidate meets a set of corresponding criteria.

2. The pattern matching method of claim 1 characterized in that said step of identifying elements as candidates further comprises the steps of:
identifying a first number appearing in a first element on a first page;
identifying a second number appearing in a second element on a second page in approximately the same position as said first number, said second page being consecutive to said first page; and
identifying said first element and said second element as said repeating elements only when the difference between said second number and said first number is equal to one.

3. The pattern matching method of claim 1 characterized in that said step of discarding said candidates further comprises the step of discarding said candidates that are not repeated on more than a selected minimum number of pages in the fixed format document.

4. The pattern matching method of claim 1 characterized in that said step of discarding said candidates further comprises the step of discarding said candidates that are not repeated on at least two consecutive pages in the fixed format document.

5. The pattern matching method of claim 1 characterized in that said step of discarding said candidates further comprises the step of discarding candidates that appear as line numbers in the fixed format document.

6. The pattern matching method of claim 1 characterized in that said step of selectively classifying a selected said candidate further comprises the step of classifying said candidate as a watermark when said candidate appears in approximately the same position on all pages of the fixed format document after the first page and all such candidates have similar content.

7. The pattern matching method of claim 6 characterized in that said step of classifying said candidate as a watermark further comprises the step of classifying said watermark as a page color when said watermark covers an area on the page equal to or greater than a selected minimum page coverage area threshold.

8. The pattern matching method of claim 6 characterized in that said step of classifying said candidate as a watermark further comprises the step of classifying said watermark as a page border when said watermark is formed from a plurality of connected elements and has a bounding box containing an area on the page equal to or greater than a selected minimum page bounding area threshold.

9. The pattern matching method of claim 1 characterized in that said step of selectively classifying a selected said candidate further comprises the step of classifying said candidate as a header when said candidate appears as the topmost element of pages in the fixed format document.

10. The pattern matching method of claim 1 characterized in that said step of selectively classifying a selected said candidate further comprises the step of classifying said candidate as a footer when said candidate appears as the bottommost element of pages in the fixed format document.

11. The pattern matching method of claim 1 characterized in that said step of selectively classifying a selected said candidate further comprises the step of classifying said candidate as a header when each element appearing above said candidate on pages in the fixed format document is also classified as a header.

12. The pattern matching method of claim 1 characterized in that said step of selectively classifying a selected said candidate further comprises the step of classifying said candidate as a footer when each element appearing below said candidate on pages in the fixed format document is also classified as a footer.

13. The pattern matching method of claim 1 further comprising the step of repeating said step of discarding said candidates that match a filter criterion after said step of selectively classifying a selected said candidate.

14. A system for detecting and classifying headers, footers, and watermarks appearing in a fixed format document, said system comprising a pattern matching engine application operable to:
identify repeating elements appearing in a similar position on multiple pages in a fixed format document as candidates;
classify said candidate as a watermark when said candidate appears in approximately the same position on all pages of the fixed format document after the first page and all such candidates have similar content;
classify said candidate as a header when each element appearing above said candidate on pages in the fixed format document is also classified as a header; and
classify said candidate as a footer when each element appearing below said candidate on pages in the fixed format document is also classified as a footer.

15. The system of claim 14 characterized in that said pattern matching engine application is operable to:
discard said candidates that are not repeated on more than a selected minimum number of pages in the fixed format document; and
discard said candidates that are not repeated on at least two consecutive pages in the fixed format document.

16. The system of claim 14 characterized in that said pattern matching engine application is operable to:
classify said watermark as a page color when said watermark covers an area on the page equal to or greater than a selected minimum page coverage area threshold; and
classify said watermark as a page border when said watermark is formed from a plurality of connected elements and has a bounding box containing an area on the page equal to or greater than a selected minimum page bounding area threshold.

17. The system of claim 14 characterized in that said pattern matching engine application is operable to:
classify said candidate as a header when said candidate appears as the topmost element of pages in the fixed format document; and
classify said candidate as a footer when said candidate appears as the bottommost element of pages in the fixed format document.

18. A computer readable medium containing computer executable instructions which, when executed by a computer, perform a method for identifying and classifying elements repeating on different pages of a fixed format document, said method comprising the steps of:
identifying elements as candidates when said elements have similar content and appear in similar positions on multiple pages in a fixed format document;
discarding said candidates further comprises the step of discarding said candidates that are not repeated on more than a selected minimum number of pages in the fixed format document;
discarding said candidates further comprises the step of discarding said candidates that are not repeated on at least two consecutive pages in the fixed format document;
discarding said candidates further comprises the step of discarding candidates that appear as line numbers in the fixed format document;
classifying said candidate as a watermark when said candidate appears in approximately the same position on all pages of the fixed format document after the first page and all such candidates have similar content;
classifying said candidate as a header when each element appearing above said candidate on pages in the fixed format document is also classified as a header; and
classifying said candidate as a footer when each element appearing below said candidate on pages in the fixed format document is also classified as a footer.

19. The computer readable medium of claim 18 characterized in that said step of classifying said candidate as a watermark further comprises the step of classifying said watermark as a page color when said watermark covers an area on the page equal to or greater than a selected minimum page coverage area threshold.

20. The computer readable medium of claim 18 characterized in that said step of classifying said candidate as a watermark further comprises the step of classifying said watermark as a page border when said watermark is formed from a plurality of connected elements and has a bounding box containing an area on the page equal to or greater than a selected minimum page bounding area threshold.
